(19) United States
(12) Patent Application Publication
(10) Pub. No.: US 2008/0176032 A1
(43) Pub. Date: Jul. 24, 2008

(54) 2D sheet that converts to a 3D lathe

(76) Inventors: Av Kerkar, Rockaway, NJ (US); Makam S. Chetan, Westford, MA (US); Vinay Mehta, Bridgewater, NJ (US)

Correspondence Address: GAF;WILLIAM J. DAVIS, ESQ., 1361 ALPS ROAD, WAYNE, NJ, 07470, US

(21) Appl. No.: 11/656,204

(22) Filed: Jan. 22, 2007

(51) Int. Cl. B32B 3/10

(52) U.S. Cl. 428/131; 52/746.1

(57) ABSTRACT

A two-dimensional foil having slits that allow the foil to convert into a three-dimensional lathe by stretching out the lathe so that the slits form pockets or openings. The lathe is made of a foil that can have a plurality of individual slits formed in parallel spaced rows extending transversely from one end to the opposing end. The foil is expandable by extending the opposing ends of the foil in a lengthwise or widthwise direction, whereby the slits form an array of openings. The length, width, spacing, number of the cuts and the extent of staggering between the rows can be varied. The two-dimensional foil can be easily stored in the non-expandable position in a roll form, allowing inexpensive and easier handling and transportation.

### BACKGROUND OF THE INVENTION

1. Field of the Invention

The present invention relates generally to a lathe, and more specifically, to a two-dimensional sheet or foil that converts into a three-dimensional lathe for installing natural and artificial stones and other suitable uses in the roofing and construction industry.

2. Prior Art

Generally, metal wire lathe is used for many building applications. One such application is under natural or artificial stone architectures where it acts as a reinforcement for concrete mixture used to adhere such stones to a vertical wall, facade or structure. The metal lathe provides pockets/spaces wherein concrete mixture when applied results in extra strength and reinforcement needed to withstand the weight load of stones in vertical or near-vertical architectures.

However, such metal lathe has significant bulk and thickness resulting in cumbersome and relatively expensive handling before it is delivered to the job site. Current metal lathes are available in forms that are essentially three dimensional, bulky and unwieldy to handle and transport. Therefore, there is a need for a more efficient lathe in the art that can reduce the bulk of the lathe so it is more easily transportable and easier to handle, before being installed.

### SUMMARY OF THE INVENTION

One object of the present invention is to provide a lathe for application in the building/construction industry that stretches from a two-dimensional flat structure into a three-dimensional form just prior to affixing it on a wall or similar substrate, to allow for normal roll forms for easier and cheaper transportation. Yet another object of the present invention is to provide a lathe with slits of different designs, lengths, widths and spacings in order to have a predetermined pattern and pockets/openings depending on the density and type of cross-slit pattern.

Accordingly, a lathe for use in building construction is provided, the lathe comprising a foil having a length, width and thickness, and one or more slits that extend throughout the foil, wherein the slits allow the foil to stretch to form openings when the foil is extended in a lengthwise or widthwise direction.

The foil can have substantially parallel rows of slits in a horizontal direction, and alternate rows of slits in the same location with respect to a vertical direction. The adjacent rows can have slits that are in a fully or partially staggered arrangement. The foil can have substantially parallel rows of slits, each row having a slit in a horizontal direction followed by a slit in a vertical direction. The foil can comprise a metal foil.

The metal foil can have substantially parallel rows of slits in a diagonal direction. The angle of the diagonal slits can be approximately forty five degrees, or approximately one hundred thirty five degrees. The lathe can comprise a plastic laminate composite material.

The metal foil can have rows of slits in a diagonal direction, and adjacent rows of slits in a cross diagonal direction. The slits in the diagonal direction can be at an approximately forty five degree angle, and the slits in the cross diagonal direction can be at an approximately one hundred thirty five degree angle.

Further provided is a method of applying a lathe for building construction, the method comprising stretching a foil having one or more slits that extend throughout the foil, wherein the slits allow the foil to stretch to form openings when the foil is extended in a lengthwise or widthwise direction, and affixing the foil to a substrate.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a top view of a lathe in two-dimensional form in accordance with a first embodiment of the present invention;

FIG. 2 illustrates a top view of a lathe in two-dimensional form in accordance with a second embodiment of the present invention;

FIG. 3 illustrates a top view of a lathe in two-dimensional form in accordance with a third embodiment of the present invention; and

FIG. 4 illustrates a top view of a lathe in two-dimensional form in accordance with a fourth embodiment of the present invention; and

FIG. 5 illustrates a top view of the lathe of FIG. 1 in three-dimensional form once stretched out.

### DETAILED DESCRIPTION OF THE PREFERRED EMBODIMENT

Although this invention is applicable to numerous and various types of applications for the building/construction industry, it has been found particularly useful in the environment of reinforcements for concrete mixtures used to adhere natural or artificial stone architectures to a vertical wall or structure. Therefore, without limiting the applicability of the invention to the above, the invention will be described in such environment.

With reference now to the drawings, the lathe of the present invention will be described. FIG. 1 illustrates one embodiment of a lathe 100 of the present invention. The lathe 100 comprises a foil having cross-slits. For purposes of illustration, a sample of the lathe 100 is shown in the figure, but is not illustrative of the length, width or thickness of the lathe 100 that may be used for application. In FIG. 1, a top view of a lathe comprised of foil is provided with its total number of slits in one direction. Although the shape of the lathe 100 is shown as rectangular, it should be understood that the lathe can come in other shapes and is not limited to the shape as shown.

The foil can have several substantially parallel rows of slits 101 and 103 along a direction 102 of the lathe 100. For purposes of illustration, seven parallel rows are shown along a direction 102 in FIG. 1. The slits 101 and 103 extend completely through the thickness of the lathe 100. The slits 101 and 103 are arranged such that alternate rows have slits 101 in substantially the same location with respect to a vertical direction A. In other words, each row has slits 101 that are fully or partially staggered.

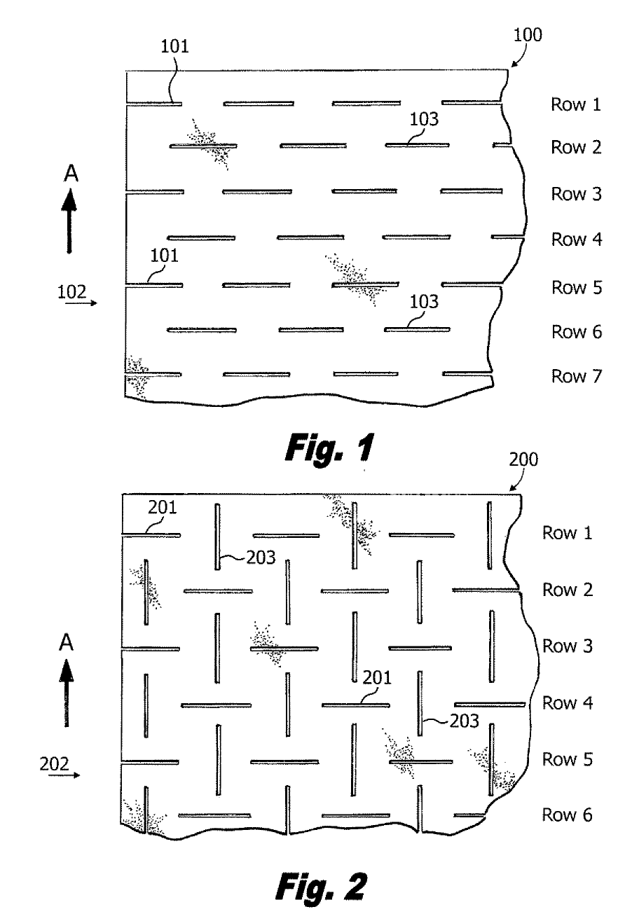

In another embodiment of the present invention, as shown in FIG. 2, adjacent slits 201 are formed in a perpendicular direction in substantially parallel rows. Accordingly, in row 1, for example, a horizontal slit 201 is followed by a vertical slit 203, which is subsequently followed by another horizontal slit 201, and so on. In row 2, the slits are arranged identical to row 1, except that the vertical slit 203 is below the horizontal slit 201 of row 1, and the horizontal slit 203 is below the vertical slit 203 of row 1. Alternate parallel rows are identical, similar to FIG. 1. Therefore, rows I and 3 have slits in identical fashion along a horizontal direction 202, and rows 2 and 4 have slits in identical fashion along a horizontal direction 202.

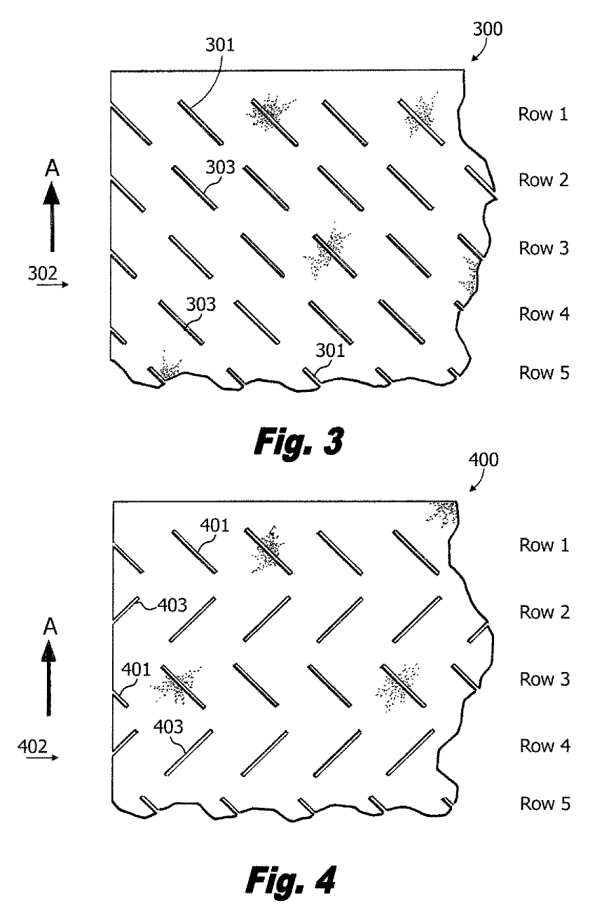

FIG. 3 shows another embodiment of the present invention in which the slits 301 and 303 are all arranged at an angle. This could be a diagonal arrangement with approximately a forty five degree angle, but the angle can be anywhere between 0 to 90 degrees. These parallel rows can also be arranged so that the slits 301 and 303 are in a cross diagonal arrangement. Alternate rows have slits in substantially the same location with respect to the direction A. In other words, each row has slits 301 and 303 that are fully or partially staggered.

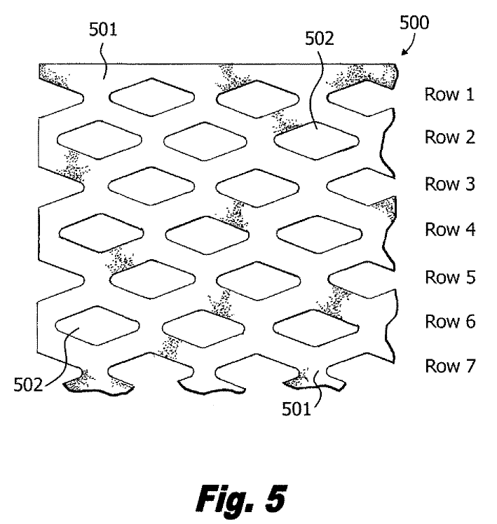

FIG. 4 shows another embodiment of the present invention in which the slits 401 and 403 are arranged in a cross-diagonal arrangement in substantially parallel rows. Specifically, alternate parallel rows having slits in a diagonal direction, and adjacent parallel rows have slits in a cross-diagonal direction. For purposes of the figure, rows 1 and 3 have slits 401 at approximately a 45 degree angle with respect to the horizontal direction 402, and rows 2 and 4 have slits 403 at approximately an 135 degree angle with respect to the horizontal direction 402. Of course, the angle of the slits 401 can range from zero to ninety degrees in rows 1 and 3, and the angle of the slits 403 can range from ninety to one hundred eighty degrees in rows 2 and 4, but is preferably at an approximately 45 degree and 135 degree angle, respectively. Alternate parallel rows have slits in substantially the same location with respect to the direction A. In other words, rows 1 and 3 have slits 401 in the same location vertically (direction A), and rows 2 and 4 have slits 403 in the same location vertically.

In all of the four embodiments described above, the slits are formed in the foil so that the slits extend through the thickness of the foil. Further, the lathe can be of any length, width or thickness, and the number of rows and length or width shown is just a sample, but can obviously be modified according to the use it is intended for. Some natural or artificial stones, depending on size, would need a smaller or greater length, width or thickness, and the present invention includes such variations to suit end-use applications. Further, the lathe can be manufactured to any shape, and is not limited to a rectangular or square shape as shown in the figures.

The lathe can be of any material, such as metal, plastic, laminate, reinforced hybrid composites or a combination thereof. A metal lathe can be made of different metals, such as steel, stainless, steel, alloy, copper, zinc, and other metals known to one of ordinary skill in the art. Further, the lathe can be a plastic (polymeric) laminate composite, an extruded cast sheet or a film—reinforced or otherwise.

Now, a method of application of the lathe of the present invention as illustrated in FIGS. 1-4 will be described. The two-dimensional lathe shown in FIGS. 1-4 can be rolled into a roll for easy and inexpensive handle and transportation. When it is time to install or use the lathe, an on-site worker can simply remove the length needed from the roll, or simply take out a flat two-dimensional piece of lathe. Then, the worker can simply stretch out the two-dimensional lathe, opening up the slits in the foil, to convert it into a three-dimensional lathe for installing natural or artificial stones, or for other suitable uses. Thus, the worker can keep the lathe in two-dimensional form until just prior to affixing it on a wall or similar substrate.

FIG. 5 shows a three-dimensional lathe 500, which corresponds to the two-dimensional lathe 100 of FIG. 1 once stretched out typically perpendicular or at an angle to the length of the slits. As seen in FIG. 5, the lathe 500 stretches so that the foil 501 opens up and takes a three-dimensional shape. Slits 502 open up forming pockets/openings to take on the three-dimensional shape required before affixing the lathe 500 on a wall or similar substrate. The lathe can be tailored to have a predetermined pattern and pockets/openings depending on the density and type of cross-slit pattern (as shown in FIGS. 1-4), and the dimensions of the cuts and their density (i.e., number of cuts per unit area).

The lathe may be of any suitable length, width, thickness and stiffness as desired. It will be appreciated that the length and width of each foil may be as long and wide as desired subject to manufacturing constraints. Moreover, it will be appreciated that it is a feature of the present invention that different cross-slit patterns, dimensions of the cuts, their density, can be modified to achieve three-dimensional lathes with different patterns and size of the pockets/openings.

The present invention provides several advantages that solve the problems with prior art methods. It provides a two-dimensional lathe that can be provided in a flat two-dimensional structure, allowing normal roll forms for easier and cheaper transportation. Then at a job site, the two-dimensional lathe can be easily stretched to form into a three-dimensional form just prior to affixing it on a wall or similar substrate. The present invention provides a lathe that stretches due to the slits and allows the foil to be easily stretched to take on a three-dimensional shape.

The cross-slit patterns shown in FIGS. 1-4 can be used, and different modifications of these embodiments can be used (such as length and width of the cuts, spacing of the cuts, etc.) to achieve various patterns and sizes of the pockets/openings of the foil. Further, slight modifications can be made in the design of the embodiments shown in FIGS. 1-4, as would be obvious to one of ordinary skill in the art, to achieve the desired lathe for the intended use.

The above description of the present invention is only the preferred embodiment of the invention. Embodiments may include any currently or hereafter-known versions of the elements described herein. Different types of metal may be used for the metal foil, and different lengths, widths, thickness and stiffness of the metal foil may be used, and different lengths, widths and spacing of the cuts may be used as well.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A lathe for use in building construction, comprising:
a foil having a length, width and thickness; and
one or more slits that extend throughout the foil;
wherein the slits allow the foil to stretch to form openings when the foil is extended in a lengthwise or widthwise direction.

2. The lathe for use in building construction of claim 1, wherein the foil has substantially parallel rows of slits in a horizontal direction.

3. The lathe for use in building construction of claim 2, wherein alternate rows have slits in the same location with respect to a vertical direction.

4. The lathe for use in building construction of claim 3, wherein adjacent rows have slits that are in a fully or partially staggered arrangement.

5. The lathe for use in building construction of claim 1, wherein the foil has substantially parallel rows of slits, each row having a slit in a horizontal direction followed by a slit in a vertical direction.

6. The lathe for use in building construction of claim 5, wherein alternate rows have slits in the same location with respect to a vertical direction.

7. The lathe for use in building construction of claim 6, wherein the foil comprises a metal foil.

8. The lathe for use in building construction of claim 7, wherein the metal foil has substantially parallel rows of slits in a diagonal direction.

9. The lathe for use in building construction of claim 8, wherein alternate rows have slits in the same location with respect to a vertical direction.

10. The lathe for use in building construction of claim 8, wherein an angle of the diagonal slits is approximately forty five degrees.

11. The lathe for use in building construction of claim 8, wherein an angle of the diagonal slits is approximately one hundred thirty five degrees.

12. The lathe for use in building construction of claim 8, wherein the lathe comprises a plastic laminate composite material.

13. The lathe for use in building construction of claim 1, wherein the metal foil has rows of slits in a diagonal direction, and adjacent rows of slits in a cross diagonal direction.

14. The lathe for use in building construction of claim 13, wherein alternate rows have slits in the same location with respect to a vertical direction.

15. The lathe for use in building construction of claim 13, wherein the slits in a diagonal direction are at an approximately forty five degree angle, and the slits in a cross diagonal direction are at an approximately one hundred thirty five degree angle.

16. A method of applying a lathe for building construction, the method comprising:
stretching a foil having one or more slits that extend throughout the foil, wherein the slits allow the foil to stretch to form openings when the foil is extended in a lengthwise or widthwise direction; and
affixing the foil to a substrate.

17. A method of applying a lathe for building construction, the method comprising:
affixing a 2-D foil having one or more slits that extend through a thickness of the foil onto a structure; and
stretching the foil such that the slits allow the foil to stretch to form openings when the foil is extended in a lengthwise or widthwise direction.
